(19) United States
(12) Patent Application Publication
(10) Pub. No.: US 2009/0171560 A1
(43) Pub. Date: Jul. 2, 2009

(54) PRIORITIZING ALTERNATIVE LANDING FACILITIES IN FLIGHT PLANNING

(76) Inventors: Nancy L. McFerran, Aurora, CO (US); Richard M. Gibson, Campbell, CA (US); Cary Hoffman, Evergreen, CO (US); Jason R. Cope, Littleton, CO (US); John J. Kelly, Parker, CO (US); Richard M. Falcone, Bedford, TX (US)

Correspondence Address: HARNESS DICKEY & PIERCE, PLC, P.O. BOX 828, BLOOMFIELD HILLS, MI, 48303, US

(21) Appl. No.: 11/968,429

(22) Filed: Jan. 2, 2008

(51) Int. Cl. G01C 21/00

(52) U.S. Cl. 701/201; 701/207

(57) ABSTRACT

A processor-performed method of aircraft flight planning. A decision point is identified along a route of the aircraft. The decision point and an anticipated range of the aircraft at the decision point are used to define an elliptical area substantially forward of the decision point and substantially along the route. Based on location of one or more landing facilities relative to the defined elliptical area, one or more of the facilities are selected as one or more alternative destinations.

### FIELD

The present disclosure relates generally to aircraft flight planning and more particularly (but not exclusively) to methods and systems for selecting alternate airports or other alternative landing facilities.

### BACKGROUND

The statements in this section merely provide background information related to the present disclosure and may not constitute prior art.

Aircraft flight planning frequently involves the selection of alternative landing facilities to which a given aircraft might travel if conditions warrant diversion of the aircraft from its primary route. Current flight planning systems typically designate one or more decision points along a primary route. For a given decision point, an alternative landing facility typically is selected based on its distance from the decision point.

### SUMMARY

The present disclosure, in one implementation, is directed to a processor-performed method of aircraft flight planning. A decision point is identified along a route of the aircraft. The decision point and an anticipated range of the aircraft at the decision point are used to define an elliptical area substantially forward of the decision point and substantially along the route. Based on location of one or more landing facilities relative to the defined elliptical area, one or more of the facilities are selected as one or more alternative destinations.

In another implementation, the disclosure is directed to an aircraft flight planning system. A processor and memory are configured to identify a decision point along a route of the aircraft, and to use the decision point and an anticipated range of the aircraft at the decision point to define an elliptical area substantially forward of the decision point and substantially along the route. Based on locations of a plurality of landing facilities relative to the defined elliptical area, the processor and memory select one or more of the landing facilities as one or more alternative destinations.

In yet another implementation, the disclosure is directed to processor-performed method of aircraft flight planning. The method includes identifying one or more decision points along a route of the aircraft. For each of the decision point(s), an ellipse is defined forward of the decision point that represents an area substantially along the route and that includes the decision point as a vertex. For each of the decision point(s), a plurality of alternative destinations are prioritized within the represented area, the prioritizing performed at least in part based on distance relative to the decision point, and based on the prioritizing, one or more alternative destinations are associated with the decision point.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a diagram of a system for aircraft flight planning in accordance with one implementation of the disclosure;

FIG. 2 is a flow diagram of a method for aircraft flight planning in accordance with one implementation of the disclosure;

FIG. 3 is a diagram illustrating how flight planning may be performed in accordance with one implementation of the disclosure; and

FIG. 4 is a diagram depicting a flight path of a flight plan in accordance with one implementation of the disclosure.

### DETAILED DESCRIPTION

The following description is merely exemplary in nature and is not intended to limit the present disclosure, application, or uses.

In various implementations of the present disclosure, user-configurable elliptical bounding areas may be used in flight planning to identify candidate landing facilities as possible alternative destinations for an aircraft. Although various implementations of the disclosure may be particularly useful in relation to planning for terrain driftdown, it should be noted that the disclosure is not so limited. There are many different reasons for which an alternative landing facility might be included in a flight plan. An alternate airport might be included to plan for overwater driftdown, terrain clearance, weather, applicable flight regulations, etc. Factors influencing the selection of alternative destinations can include fuel availability, distances to candidate landing facilities, and landing facility physical characteristics. In some implementations of the disclosure, a set of candidate landing facilities may be prioritized in accordance with user specifications to determine one or more alternate landing facilities for diverting flights relative to an identified decision point.

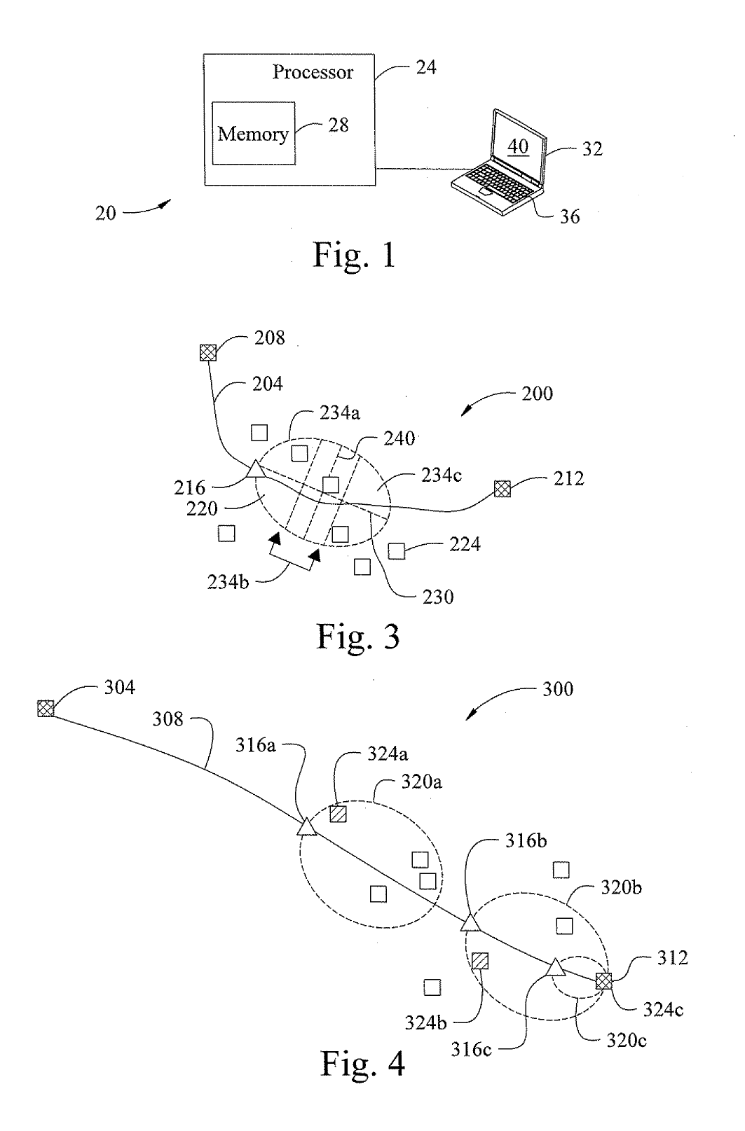

One configuration of a system for aircraft flight planning is indicated generally in FIG. 1 by reference number 20. The system 20 includes one or more processors 24, one of which is shown in FIG. 1, and associated memory 28. The processor(s) 24 and memory 28 may be located, e.g., at ground facilities of an airline, on board an aircraft, and/or distributed between or among ground and/or air platforms. The system 20 also includes a user interface 32 having a keyboard 36 or other input device and a display 40 or other output device. It will be understood by those knowledgeable in the art that many processing, memory and/or user interface configurations could be used, including but not limited to computers, microprocessors, electronic flight bags, etc. The processor(s) and memory include and/or are in communication with one or more data sources (not shown) that may provide weather data, aircraft performance data, airport data, and/or obstruction data.

The system 20 is configured to calculate, among other things, a primary route, i.e., a planned route of flight, for a given aircraft. It should be noted, however, that although various implementations may be described in the disclosure with reference to “primary” and/or “planned” routes, implementations are possible in relation to revised and/or amended routes of an aircraft. The system 20 also may calculate a primary flight profile, i.e., planned flight speeds and altitudes, for the aircraft. Calculations of primary route and primary flight profile are typically based on user parameters and assume the absence of factors such as engine failure.

Additionally or alternatively, e.g., in order to comply with applicable aviation flight planning regulations, the system 20 is configured to include planning for events such as engine failure and/or loss of altitude. For example, the system 20 may provide a plan calling for the aircraft to fly, using fewer than all of its engines, to an alternative landing facility while maintaining an altitude that complies with applicable regulations. Further, a flight plan may be provided that calls for the aircraft to fly to an alternate landing facility while maintaining an altitude sufficient to avoid mountains or other intervening terrain. Selection by the system 20 of an alternate landing facility may be based at least in part on characteristics of candidate landing facilities such as runway dimensions and/or runway weight-bearing capability.

In various implementations, the system 20 may identify one or more decision points along a route for a given aircraft. A decision point is reached, e.g., when the aircraft is no longer in range of a predefined alternate landing facility. At such a decision point, an alternative landing facility may be selected for the aircraft. In various implementations the system 20 uses a decision point and an anticipated range of the aircraft at the decision point to define an elliptical area substantially forward of the decision point and substantially along the route. Based on locations of a plurality of landing facilities relative to the defined elliptical area, the system 20 selects one or more of the landing facilities as one or more alternative destinations.

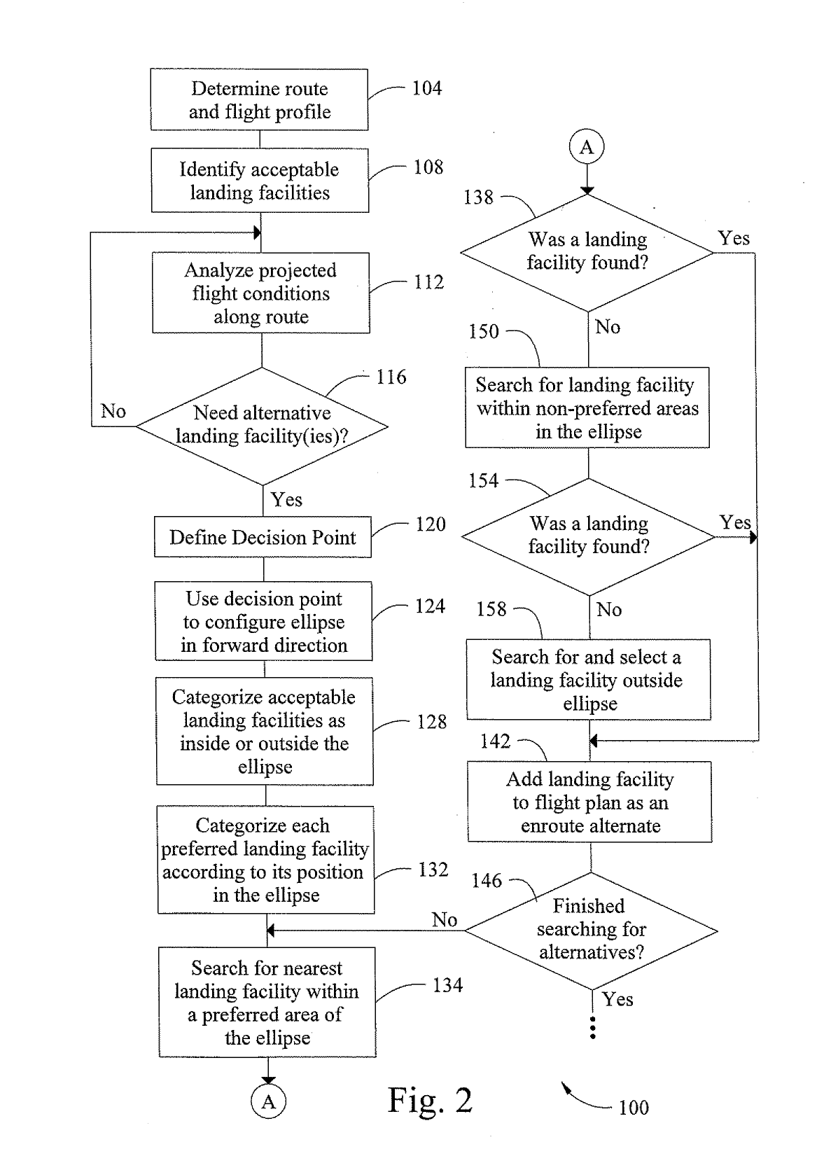

One method of aircraft flight planning in accordance with one implementation of the disclosure is indicated generally in FIG. 2 by reference number 100. The method 100 may be performed, e.g., at least in part by processor(s) 24 on the ground to assist an aircraft before and/or during flight. Additionally or alternatively, the method 100 could be performed at least in part on board an aircraft, e.g., in a laptop or other on-board flight planning system. In process 104, a route and flight profile are determined. In process 108, landing facilities that would be acceptable as alternate landing facilities for the given aircraft are identified and stored, e.g., in memory 28. In various implementations, a list of substantially all acceptable landing facilities worldwide for a particular aircraft type may be compiled, stored and kept updated. Acceptability may be based, for example, on aircraft dimensions and weight, runway dimensions, runway load capacity, refueling facilities, etc.

In process 112 projected flight conditions are analyzed relative to various points along the route to determine whether a decision point is reached. Analysis may include but is not necessarily limited to determining whether the aircraft would be able to return to its point of departure or to another previously selected alternate airport in the event of a possible engine failure and/or possible lack of altitude sufficient to negotiate high terrain to be encountered along the route. Reasons for creating decision points can include, e.g., compliance with applicable flight regulations, provision of equal time point (ETP) decision points, provision of decision points for general equipment, depressurization, weather, and/or emergencies (e.g., on long over-water flights) and/or to provide for air-to-air refueling.

If in process 116 projected flight conditions at a given point on the route indicate that a selection of alternative landing facilities is to be made, then in process 120 a decision point is defined at the given point. In process 124, starting at the decision point, an ellipse is configured substantially along the route in a direction forward of the decision point.

A diagram illustrating how flight planning may be performed in accordance with the method 100 is indicated generally in FIG. 3 by reference number 200. A route 204 for a given aircraft extends between a point of departure 208 and a point of arrival 212. A decision point 216 has an associated elliptical area 220. An ellipse may be configured in various ways based on user preference as further described below. Several landing facilities 224 are also shown in FIG. 3.

Referring again to FIG. 2, in process 128, each of the acceptable landing facilities identified in process 108 is categorized as being either inside or outside the ellipse 220. In the present example, acceptable landing facilities 224 inside the ellipse 220 may be preferred over those outside the ellipse 220. In various implementations, areas inside the ellipse 220 may be defined and prioritized based, for example, on distance from the decision point 216 and/or distance from a central axis 230 of the ellipse extending from the decision point 216. In the present example, the ellipse 220 is divided into three areas 234a, 234b and 234c. The areas 234a-c are prioritized based on distance from the decision point 216 as measured along the central axis 230. It should be noted that there are many ways in which areas of the ellipse could be prioritized. Other criteria for prioritizing areas of the ellipse could include, e.g., presence or absence of difficult terrain, current weather conditions in areas of the ellipse, etc.

In process 132, each acceptable landing facility 224 inside the ellipse 220 is prioritized according to its position in the ellipse, e.g., according to the prioritized area 234 in which it is located. It should be noted that there are many ways in which acceptable landing facilities 224 inside the ellipse 220 could be prioritized. In some implementations, for example, each acceptable landing facility 224 in the ellipse 220 could be prioritized individually, e.g., based simply on its location inside the ellipse 220 relative to the decision point 216. In various implementations, prioritizing of landing facilities outside the ellipse 220 also is performed, based, e.g., on distance from the decision point.

In process 134, a search is made for the nearest acceptable landing facility 224 to the decision point 216 within a preferred area of the ellipse 220, e.g., the area 234a. If in process 138 such a landing facility is found, then in process 142 it is added to the flight plan as a possible alternate landing facility. It may or may not be desirable to provide more than one alternative landing facility. If in process 146 it is determined that there are enough alternate landing facilities in the plan, then the updated flight plan is output, e.g., via the display 40 to a pilot of the aircraft. Otherwise the search continues in process 134. If in process 138 no landing facility is found, then in process 150 searches are made, in order of priority, for landing facilities in non-preferred areas 234b and 234c of the ellipse. if a landing facility is found in process 154, then it is added to the flight plan in process 142. If no landing facility is found inside the ellipse 220, then in process 158 a search is made outside the ellipse 220 for an acceptable landing facility 224.

An ellipse may be configured in various ways dependent on user preference. For example, a major axis of an ellipse for a given aircraft may have a length based on a range of the aircraft (which could depend, e.g., on fuel availability, head or tail winds, etc.) at the decision point. In such case the major axis would extend between the decision point and a point designated by an appropriate mileage marker along the route. Thus, as one example, a major axis may be configured at 300 nautical miles from the decision point along the route. A minor ellipse axis 240 may be selected, e.g., as a percentage value of the major axis. Thus, e.g., where a minor axis is specified as 100 percent of the major axis, the resulting ellipse is a circle.

In various implementations, a point of departure may be designated as an alternative landing facility. It may be determined for various points along the route whether, after aircraft takeoff, the aircraft could reach its first enroute alternate destination, typically defined as the aircraft's point of departure 208. At a location of the aircraft along the route from which it is determined that the aircraft could not reach its first enroute alternate destination, the system 20 defines a decision point on the route.

A diagram depicting a flight path of a flight plan in accordance with one implementation of the disclosure is indicated generally in FIG. 4 by reference number 300. The plan 300 includes a point of departure 304, a route 308 and a point of arrival 312. Three decision points 316a-c are shown with associated ellipses 320a-c. For each decision point, one alternative landing facility is shown as having been selected, namely, facilities 324a-c. Alternative facility 324c is the point of arrival. The ellipse 320c is shorter than the ellipses 320a and 320c because the point of arrival is used to define the major axis length for the ellipse 320c.

Various implementations of the foregoing systems and methods can provide a more practical selection of alternate landing facilities for emergency diversion situations than could previous selection methods. Decision points and the selection of alternate landing facilities can be optimized to minimize flight distances and to avoid solutions requiring backwards flight. Because more accurate fuel loads can be calculated for reaching divert landing facilities, aircraft fuel can be saved. Reducing fuel requirements results in lower operating expenses for aircraft operators.

While various embodiments have been described, those skilled in the art will recognize modifications or variations which might be made without departing from the present disclosure. The examples illustrate the various embodiments and are not intended to limit the present disclosure. Therefore, the description and claims should be interpreted liberally with only such limitation as is necessary in view of the pertinent prior art.

What is claimed is:

1. A processor-performed method of aircraft flight planning, the method comprising:
identifying a decision point along a route of the aircraft;
using the decision point and an anticipated range of the aircraft at the decision point to define an elliptical area substantially forward of the decision point and substantially along the route; and
based on location of one or more landing facilities relative to the defined elliptical area, selecting one or more of the facilities as one or more alternative destinations.

2. The method of claim 1, further comprising using the decision point as a vertex of a major axis of the elliptical area.

3. The method of claim 1, further comprising selecting a landing facility based on terrain between the route and the landing facility.

4. The method of claim 1, wherein selecting one or more of the landing facilities comprises ranking the landing facilities based on proximity to the route.

5. The method of claim 1, wherein selecting one or more of the landing facilities comprises preferring one or more landing facilities within the elliptical area.

6. The method of claim 1, further comprising:
defining an offset based on a wind pattern along the route; and
using the offset to define the elliptical area.

7. The method of claim 1, wherein selecting one or more of the landing facilities comprises ranking the landing facilities based on proximity to one or more of the following: a vertex of the elliptical area, and the center of the elliptical area.

8. An aircraft flight planning system comprising a processor and memory configured to:
identify a decision point along a route of the aircraft;
use the decision point and an anticipated range of the aircraft at the decision point to define an elliptical area substantially forward of the decision point and substantially along the route; and
based on locations of a plurality of landing facilities relative to the defined elliptical area, select one or more of the landing facilities as one or more alternative destinations.

9. The system of claim 8, the processor and memory configured to use the decision point as a vertex of a major axis of the elliptical area.

10. The system of claim 8, the processor and memory configured to select a landing facility based on terrain between the route and the landing facility.

11. The system of claim 8, wherein to select one or more of the landing facilities comprises ranking the landing facilities based on proximity to the route.

12. The system of claim 8, wherein to select one or more of the landing facilities comprises preferring one or more landing facilities within the elliptical area.

13. The system of claim 8, the processor and memory configured to:
define an offset based on a wind pattern along the route; and
use the offset to define the elliptical area.

14. A processor-performed method of aircraft flight planning, the method comprising:
identifying one or more decision points along a route of the aircraft; and
for each of the one or more decision points:
defining an ellipse forward of the decision point that represents an area substantially along the route and that includes the decision point as a vertex;
prioritizing a plurality of alternative destinations within the represented area, the prioritizing performed at least in part based on distance relative to the decision point; and
based on the prioritizing, associating one or more alternative destinations with the decision point.

15. The method of claim 14, wherein prioritizing further comprises prioritizing one or more alternative destinations that lie outside the represented area.

16. The method of claim 14, performed upon a determination that a point of departure of the aircraft is not in range of the aircraft.

17. The method of claim 14, further comprising defining a major axis of the ellipse substantially along the route.

18. The method of claim 17, further comprising defining the major axis and a minor axis of the ellipse based on user-supplied parameters.

19. The method of claim 14, further comprising using a point of arrival of the aircraft as a vertex of the ellipse.

20. The method of claim 14, further comprising defining the ellipse based at least in part on weather conditions.

21. The method of claim 14, the prioritizing performed at least in part based on direction relative to the route.
